(19) United States
(12) Patent Application Publication
(10) Pub. No.: US 2021/0144185 A1
(43) Pub. Date: May 13, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Yusuke SAKAI, Kanagawa (JP); Tadamichi SHIMOGAWARA, Kanagawa (JP)

(73) Assignee: SONY CORPORATION, Tokyo (JP)

(21) Appl. No.: 17/086,777

(22) Filed: Nov. 2, 2020

(30) Foreign Application Priority Data
Nov. 7, 2019 (JP) 2019-202082

(51) Int. Cl. H04L 29/06; H04R 5/04; H04R 3/00

(52) U.S. Cl. CPC H04L 65/403; H04L 65/1066; H04R 3/005; H04R 5/04

(57) ABSTRACT

An information processing apparatus includes a presentation processing unit. The presentation processing unit executes, when a specific sound is generated at another point other than one of a plurality of points, presentation processing for presentation indicating that the specific sound generated at the other point is not a sound generated at the one point. Each of the plurality of points has a telepresence apparatus constituting a telepresence system that performs bidirectional communication of images and sounds for communication between users located at the plurality of points.

### CROSS REFERENCE TO RELATED APPLICATIONS

This application claims the benefit of Japanese Priority Patent Application JP 2019-202082 filed Nov. 7, 2019, the entire contents of which are incorporated herein by reference.

### BACKGROUND

The present technology relates to an information processing apparatus, an information processing method, and a program, and more particularly to, an information processing apparatus, an information processing method, and a program that are capable of suppressing misunderstandings, for example.

A video conference system for automatically and accurately capturing an image of a speaker has been proposed (see, for example, Japanese Patent Application Laid-open No. 2005-086365).

### SUMMARY

Incidentally, a telepresence system has attracted attention as a communication tool capable of enjoying a feeling of facing each other between users at remote locations.

In the telepresence system, bidirectional communication of images and sounds between remote spaces is performed in the spaces. In recent years, the telepresence system can provide an environment where spaces at remote locations exist like a connected space at the same place, because of the improvement in quality of images and sounds, i.e., the improvement in image quality and sound quality.

In a case where points A and B are connected in such a telepresence system, a signal sound of a telephone call, a chime sound of an entrance, or an emergency bell generated at one of the points A and B, for example, at the point B, is transmitted to the other point A for output.

In this case, because of the improved sound quality of the telepresence system, there is a possibility that a user at the point A mistakes the signal sound, which has been generated at the point B and output by the telepresence system, as a signal sound generated at the point A, and makes an unnecessary reaction or mistakenly thinks that an emergency occurs.

The present technology has been made in view of the circumstances as described above and is capable of suppressing misunderstandings.

According to an embodiment of the present technology, there is provided an information processing apparatus or a program that causes a computer to function as such an information processing apparatus, the information processing apparatus including a presentation processing unit that executes, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

According to another embodiment of the present technology, there is provided an information processing method including executing, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

In the present technology, when a specific sound is generated at another point other than one of a plurality of points, presentation processing for presentation is executed, the presentation indicating that the specific sound generated at the other point is not a sound generated at the one point, each of the plurality of points having a telepresence apparatus constituting a telepresence system that performs bidirectional communication of images and sounds for communication between users located at the plurality of points.

The information processing apparatus may be an independent apparatus or may be an internal block constituting one apparatus.

Further, the program can be provided by being recorded on a recording medium or by being transmitted via a transmission medium.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a configuration example of an embodiment of a telepresence system to which the present technology is applied;

FIG. 2 is a block diagram showing a configuration example of a telepresence apparatus 11A;

FIG. 3 is a block diagram showing a configuration example of a signal processing unit 51;

FIG. 4 is a perspective view for describing an example of use of the telepresence apparatus 11;

FIG. 5 is a flowchart for describing an example of processing of the telepresence system 10;

FIG. 6 is a diagram showing a first example of a state of communication using the telepresence system 10;

FIG. 7 is a diagram showing a second example of a state of communication using the telepresence system 10;

FIG. 8 is a diagram showing a third example of a state of communication using the telepresence system 10;

FIG. 9 is a diagram showing a fourth example of a state of communication using the telepresence system 10; and

FIG. 10 is a block diagram showing a configuration example of an embodiment of a computer to which the present technology is applied.

### DETAILED DESCRIPTION OF EMBODIMENTS

Telepresence System to which Present Technology is Applied

FIG. 1 is a diagram showing a configuration example of an embodiment of a telepresence system to which the present technology is applied.

A telepresence system 10 performs bidirectional communication of images and sounds for communication between users located at a plurality of points.

In FIG. 1, the telepresence system 10 includes telepresence apparatuses 11A and 11B and a server 12.

The telepresence apparatus 11A is disposed at a certain point A, and captures an image and collects a sound at the point A to transmit them to the telepresence apparatus 11B at a point B.

Further, the telepresence apparatus 11A receives and presents an image and a sound, which are captured and collected by the telepresence apparatus 11B and then transmitted from the telepresence apparatus 11B, i.e., displays an image and outputs a sound. Thus, the telepresence apparatus 11A displays the space of the point B, for example, as if the space of the point A and the space of the point B were directly connected to each other.

The telepresence apparatus 11B is disposed at a point B different from the point A, and performs processing similar to that of the telepresence apparatus 11A.

In other words, the telepresence apparatus 11B captures an image and collects a sound at the point B to transmit them to the telepresence apparatus 11A at the point A.

Further, the telepresence apparatus 11B receives and presents an image and a sound, which are captured and collected by the telepresence apparatus 11A and then transmitted from the telepresence apparatus 11A. Thus, the telepresence apparatus 11B displays the space of the point A, for example, as if the space of the point A and the space of the point B were directly connected to each other.

Here, when it is unnecessary to distinguish between the telepresence apparatuses 11A and 11B, they will also be referred to as the telepresence apparatus 11.

The server 12 controls the telepresence apparatus 11 and provides information necessary for the telepresence apparatus 11 to the telepresence apparatus 11 as necessary.

Note that, in the telepresence system 10 of FIG. 1, the bidirectional communication of images and sounds is performed at two points of the points A and B, but the bidirectional communication of images and sounds can be performed at, in addition to the points A and B, three points including the points A and B and another point C, or four or more points.

In the following, for simplicity of explanation, the telepresence system 10 performs interactive communication of images and sounds at two points, i.e., the point A and the point B.

The telepresence system 10 constantly connects the points A and B serving as, for example, a plurality of remote points, to exchange images and sounds of the points A and B in real time. Thus, the telepresence system 10 allows the users of the points A and B to enjoy a feeling as if they were in a close space, thus providing an interactive environment.

In the telepresence system 10, a plurality of distant points, for example, between offices of the same company, between medical facilities, between nursing facilities, between facilities for the elderly, between public facilities, between nursing facilities or facilities for the elderly and homes, etc. can be connected. At each point connected by the telepresence system 10, sounds generated at other points are propagated realistically.

Thus, in a case where the points A and B are connected in the telepresence system 10 and when a signal sound of a telephone call, a chime sound of an entrance, an emergency bell, or the like generated at one of the points A and B, for example, at the point B, is transmitted and output to the other point A, the user of the point A may mistake the signal sound generated at the point B as one generated at the point A and may be confused without knowing at which point what is occurring.

In this regard, in the telepresence system 10, when a specific sound that is a specific signal sound is generated at another point B other than a point A, which is one of the points A and B serving as a plurality of points where the telepresence apparatuses 11A and 11B constituting the telepresence system 10 are disposed, presentation processing for presentation indicating that the specific sound generated at the other point B is not a sound generated at the point A is executed.

In other words, the telepresence system 10 detects the specific sound generated at each of the points A and B.

The telepresence system 10 then acoustically processes the specific sound generated at the point A in the presentation processing in accordance with the situation, for example, to convert the specific sound into another sound that is heard in a different way from that of the specific sound, and outputs the sound at a point other than the point A (here, the point B).

In addition, the telepresence system 10 acoustically processes the specific sound generated at the point B in the presentation processing in accordance with the situation, for example, to convert the specific sound into another sound that is heard in a different way from that of the specific sound, and outputs the sound at a point other than the point B (here, the point A).

As described above, at the point A or B, the specific sound generated at the other point B or A is acoustically processed to be converted into another sound that is heard in a different way from that of the specific sound and then output, and thus the user at the point A or B who has heard the “other sound” can recognize that the “other sound” is not the sound generated at the point A or B.

Therefore, in the presentation processing of converting the specific sound into another sound, it can be said that presentation indicating that the specific sound generated at the other point B or A is not the sound generated at the point A or B is performed for the user at the point A or B.

Note that, in the telepresence system 10, the specific sound generated at the point A can be muted at the point B depending on the situation. Similarly, the specific sound generated at the point B can be muted at the point A.

As described above, the specific sound generated at the point B or A is acoustically processed and output at the point A or B, respectively, and thus the users at the points A and B can distinguish the specific sounds generated at the points A and B, respectively.

Therefore, according to the telepresence system 10, the user at each point can properly grasp the situation of each point (the composite space to which the points are connected) without mistaking the point where the specific sound is generated, while maintaining the original effect of the telepresence system 10 that improves the quality of association between the users in both spaces by constantly connecting the points A and B.

Here, the term “signal sound” is defined in acoustic ecology (Schafer's classification of sounds) as a signal sound (sound to which people pay attention, a bell, a horn, a siren, a command, etc.) and a sound mark (sound of a clock tower of a city, a chime of bells, a sound of walking on a stone pavement, etc.), in contrast to a fundamental sound (sound constantly heard in a space, background noise, etc.). The “signal sound” is usually heard in a limited area in association with a specific space. In a broad sense, the “signal sound” may also include sounds of lightning, rain, wind, and the like.

In the telepresence system 10, among the signal sounds respectively generated at the points A and B, a signal sound to be detected as a specific sound can be learned in advance.

Further, in the telepresence system 10, for example, all or part of a signal sound generated in common at each of the points A and B can be detected as a specific sound.

In addition, in the telepresence system 10, characteristics and effects of a specific sound (e.g., what action a user who has listened to the specific sound takes) are analyzed, and presentation processing or the like to be performed on the specific sound can be dynamically determined in accordance with the analysis result.

In the telepresence system 10, the information of the detected specific sound or the contents of the presentation processing or the like to be performed on the specific sound can be displayed as a user interface (UI) and fed back to the users at the points A and B. For example, in the telepresence system 10, in a case where a telephone call generated at the point B is detected as a specific sound, and the telephone call serving as the specific sound is muted at the point A other than the point B, the fact that the telephone call is ringing at the point B (the information of the detected specific sound) and that the telephone call is muted (the contents of the processing performed on the telephone call) can be displayed at the point A.

In addition to muting, the presentation processing can be performed on the specific sound. The presentation processing is processing for presentation indicating that, when a specific sound is generated at another point other than one point, the specific sound generated at the other point is not a sound generated at the one point.

According to the presentation processing, for example, presentation indicating that, when a specific sound is generated at the point B, the specific sound generated at the point B is not a sound generated at the point A (hereinafter, also referred to as “non-occurrence presentation”) is performed at the point A.

For example, in the presentation processing, the specific sound generated at the point B is converted in terms of a tone, a sound source, or a melody, and then output at the point A.

As described above, since the specific sound generated at the point B is converted in terms of a tone or the like and then output at the point A, the user at the point A can recognize that the specific sound, which is converted in terms of a tone or the like and then output at the point A, is not a sound generated at the point A.

Therefore, converting a tone or the like of the specific sound generated at the point B and outputting the converted specific sound at the point A can be the non-occurrence presentation indicating that the specific sound generated at the other point B is not a sound generated at the point A.

In a case where the same specific sound as that at the point B is also generated at a point C other than the point B, sounds having different tones or the like can be employed at the point A as a sound when the specific sound generated at the point B is output and a sound when the specific sound generated at the point C is output.

In this case, the user of the point A can recognize at which point what is occurring, that is, can recognize that a certain identical specific sound is generated at each of the points B and C.

For example, the telepresence system 10 can set a nursing staff room as one point and set each floor of each hospital ward under the jurisdiction of each nursing staff of the nursing staff room as another point, and connect the nursing staff room and each floor of each hospital ward to each other. In this case, when a so-called nurse call rings on one of the floors, the nursing staff in the nursing staff room can hear the sound and instantly grasp on which floor the nurse call is ringing.

In addition, the telepresence system 10 can connect support centers for providing support by telephone service distributed at a plurality of points, for example.

In this case, the staff of each support center can instantly grasp in which support center the telephone is ringing. Further, the staff of a support center where there is staff who is free (hereinafter, also referred to as an “idle support center”) can cope with a telephone call coming to another support center. In a case where the voice of the staff of the idle support center is transmitted to another support center, the voice of the staff of the idle support center can be transmitted to another support center as it is. Further, the voice of the staff of the idle support center can be detected and separated from a collected sound and transmitted to another support center.

Here, the existing video conference system is often used in a specific conference room for a specific time with a specific purpose. The conference room in which the video conference system is used is basically shielded and is an environment where environmental sounds are hard to hear. For that reason, the video conference system fails to provide a feeling as if the users of the connected spaces were natural communication partners located at the same place.

In contrast to this, the telepresence system 10 transmits and receives daily environmental sounds in each space, simple conversations, and occurrences by images and sounds, and thus constantly connects a plurality of spaces with a high reality. This allows the user in each space to perceive another space or a user in another space more naturally and comfortably. As a result, the quality of relationships across distances among people belonging to a team or organization can be improved.

However, in the telepresence system 10, a sound in the remote space is heard as if it were generated in the same space. Thus, assuming a physical distance attenuation of the sound in the space, a signal sound perceived within a specific range of the space is perceived also by an unintentional subject in an unintentional space. In other words, the user of the point A may mistake the signal sound generated at the other point B, which is output by the telepresence system 10, as the signal sound generated at the point A.

In this regard, in the telepresence system 10, in a case where a specific sound is generated at another point other than one of a plurality of points where the telepresence apparatuses 11 are disposed, presentation processing for presentation indicating that the specific sound generated at the other point is not a sound generated at the one point is executed.

For example, in the telepresence system 10, presentation processing in which a specific sound is detected and separated from a collected sound and is acoustically processed to be output, or the like is executed. Further, the contents of the presentation processing are displayed and fed back to the user as necessary.

Thus, in the telepresence system 10, it is possible to prevent the user from mistaking the signal sound generated at the other point as a signal sound generated at the point where the user is located, and from unnecessarily reacting, while maintaining the effect of constantly connecting a plurality of spaces with a high reality.

In addition, it is possible to grasp a high-level composite space state, for example, in which space which sound (specific sound) is generated, for a composite space in which a plurality of spaces is connected with a high reality.

### Configuration Example of Telepresence Apparatus 11A

FIG. 2 is a block diagram showing a configuration example of the telepresence apparatus 11A.

Note that the telepresence apparatus 11B is also configured similarly to the telepresence apparatus 11A of FIG. 2.

The telepresence apparatus 11A includes an input device 21, an output device 22, and a signal processing device 23.

The input device 21 senses information (physical quantity) and supplies the information to the signal processing device 23. In FIG. 2, the input device 21 includes a microphone 31, a camera 32, and a sensor 33.

The microphone 31 collects (senses) a sound and supplies the sound to the signal processing device 23. The camera 32 captures an image (senses light) and supplies it to the signal processing device 23. The sensor 33 senses, for example, biological information such as a body temperature, a sweat volume, a blood pressure, and a heart rate of the user, and other physical quantities such as an ambient temperature and a distance, and supplies the sensed information to the signal processing device 23. The physical quantities sensed by the sensor 33 are not particularly limited.

The output device 22 performs various outputs under the control of the signal processing device 23. In FIG. 2, the output device 22 includes a loudspeaker 41, a display 42, and an actuator 43.

The loudspeaker 41 and the display 42 present information. The loudspeaker 41 outputs the information by a sound. The display 42 displays the information by an image. The actuator 43 vibrates, for example. In addition to the actuator that vibrates, an actuator for adjusting temperatures, an actuator for generating odor or wind, or any other optional actuators can be employed for the actuator 43.

Here, in FIG. 2, the microphone 31 to the sensor 33, and the loudspeaker 41 to the actuator 43 are illustrated one by one, but a plurality of microphones 31, a plurality of cameras 32, a plurality of sensors 33, a plurality of loudspeakers 41, a plurality of displays 42, and a plurality of actuators 43 may be provided as appropriate.

The signal processing device 23 performs necessary processing on the information supplied from the input device 21, and transmits the resultant information to, for example, the telepresence apparatus 11B as another telepresence apparatus, as necessary. Further, the signal processing device 23 receives information transmitted from, for example, the telepresence apparatus 11B as another telepresence apparatus, performs necessary processing thereon, and as necessary, causes the output device 22 to output (present) the resultant information.

The signal processing device 23 includes a signal processing unit 51, a communication unit 52, and a recording unit 53.

The signal processing unit 51 performs necessary processing on the sound and image respectively supplied from the microphone 31 and the camera 32 of the input device 21, and supplies them to the communication unit 52.

Further, the signal processing unit 51 performs necessary processing on the sound and the image from the telepresence apparatus 11B, which are supplied from the communication unit 52, and causes the loudspeaker and the display 42 of the output device 22 to present the sound and the image, respectively. In other words, the signal processing unit 51 causes the loudspeaker 41 to output the sound, and the display 42 to display the image.

In addition, the signal processing unit 51 detects (and separates) a specific sound from the sound collected by the microphone 31 or from the sound from the telepresence apparatus 11B, which is supplied from the communication unit 52.

Further, in a case where a specific sound is included in the sound from the telepresence apparatus 11B, that is, in a case where a specific sound is generated at the point (other point) B where the telepresence apparatus 11B is disposed, the signal processing unit 51 executes presentation processing for presentation indicating that the specific sound generated at the point B is not a sound generated at the point (one point) A where the telepresence apparatus 11A is disposed.

The communication unit 52 communicates with the server 12 and the telepresence apparatus 11B. For example, the communication unit 52 transmits the sound and image supplied from the signal processing unit 51 to the telepresence apparatus 11B. Further, for example, the communication unit 52 receives the sound and image transmitted from the telepresence apparatus 11B and supplies them to the signal processing unit 51.

The recording unit 53 records various types of information. For example, the recording unit 53 records information that is handled by the signal processing unit 51 and the communication unit 52, information that is input from the outside of the telepresence apparatus 11A, and the like. The information recorded in the recording unit 53 can be used for processing by the signal processing unit 51 or the like.

### Configuration Example of Signal Processing Unit 51

FIG. 3 is a block diagram showing a configuration example of the signal processing unit 51.

The signal processing unit 51 includes a specific sound detection unit 61 and a presentation processing unit 62.

The specific sound detection unit 61 detects a specific sound from a sound collected by the microphone 31 at the point on its own side or a sound from another point supplied from the communication unit 52, and supplies the detection result to the presentation processing unit 62 or the like.

In a case where a specific sound is generated at another point other than the point (one point) on its own side, the presentation processing unit 62 executes presentation processing for presentation indicating that the specific sound generated at the other point is not a sound generated at the point on its own side, as necessary.

In the presentation processing, for example, the specific sound can be acoustically processed and output from the loudspeaker 41. The acoustic processing for the specific sound includes, for example, shifting the pitch of the specific sound only by a half tone or the like and converting the specific sound into another sound. Further, in the presentation processing, the fact that the specific sound is generated at the other point can be displayed on the display 42. In this case, the presentation processing unit 62 can acoustically process the specific sound together. Further, in the presentation processing, in a case where the fact that the specific sound is generated at the other point is displayed on the display 42, the presentation processing unit 62 can output the specific sound as it is without processing the specific sound, or can mute the specific sound (limit the output of the specific sound).

In a case where the presentation processing unit 62 executes the presentation processing, the contents of the presentation processing can be displayed on the display 42.

### Example of Use of Telepresence Apparatus 11

FIG. 4 is a perspective view for describing an example of use of the telepresence apparatus 11.

The telepresence apparatus 11 includes the microphone 31, the camera 32, and the sensor 33 constituting the input device 21, the loudspeaker 41, the display 42, and the actuator 43 constituting the output device 22, and the signal processing device 23.

Note that the illustration of the sensor 33 is omitted in FIG. 4. Further, in FIG. 4, the microphone 31 and the camera 32 are integrally configured.

The telepresence apparatus 11 can provide, for example, a communication experience in which users at remote locations, e.g., a user at a point A and a user at a point B, are close to each other.

Hereinafter, the user side in front of the display 42 shown in FIG. 4 will be referred to as a user's side, and the user side projected on the display 42 will be referred to as the other side, as appropriate. For example, if the telepresence apparatus 11 on the user's side is the telepresence apparatus 11A at the point A, the telepresence apparatus 11 on the other side is, for example, the telepresence apparatus 11B at the point B.

The loudspeaker 41 outputs a sound transmitted from the telepresence apparatus 11 on the other side. The display 42 displays an image transmitted from the telepresence apparatus 11 on the other side, and displays the space of the other side on the screen.

The microphone 31 collects a sound on the user's side. The camera 32 captures an image of the space on the user's side. The sound collected by the microphone 31 and the image captured by the camera 32 are transmitted to the telepresence apparatus 11 on the other side and presented in a manner similar to the telepresence apparatus 11 on the user's side.

In the telepresence apparatus 11, for example, a specific sound is detected from the sound on the user's side collected by the microphone 31 or the sound transmitted from the telepresence apparatus 11 on the other side.

The sound serving as a specific sound to be detected can be set in advance and recorded in the recording unit 53.

Further, in the telepresence apparatus 11, all or part of a signal sound generated in common at each of the point on the user's side and the point on the other side can be dynamically set as a sound to be detected as a specific sound.

When a specific sound generated at a point on the other side is detected, the telepresence apparatus 11 determines whether to execute the presentation processing for the specific sound, and if executing the presentation processing, determines (the contents of) the presentation processing to be executed and then executes the presentation processing.

In the telepresence apparatus 11, the presence/absence of the execution of the presentation processing (whether to execute the presentation processing) and the presentation processing to be executed can be determined according to a preset presentation rule, for example. The presentation rule can be recorded in the recording unit 53.

Further, the telepresence apparatus 11 can recognize context information (state or situation) of the point on the user's side or a user who appears in the image captured by the camera 32. In this case, the presence/absence of the execution of the presentation processing and the presentation processing to be executed can be determined according to the recognized context information (state or situation), user information regarding the recognized user, and the like.

For example, in a case where a conversation becomes lively between the user on the user's side and the user on the other side by the recognition of the context information and the users, and in addition, the detected specific sound is recognized as a sound irrelevant to the users performing the conversation, it is possible to determine not to perform the presentation processing in order to prevent the conversation from being interrupted.

In addition, in this case, in order to prevent the conversation from being interrupted, the telepresence apparatus 11 on the user's side can determine to mute (or suppress) the specific sound generated at the point on the other side and can mute the specific sound.

In a case of muting the specific sound generated at the point on the other side or in the case of executing the presentation processing on the specific sound generated at the point on the other side, the telepresence apparatus 11 can provide feedback (notification) to the user by displaying the contents of the processing.

Examples of the method of muting the specific sound include a method of superimposing a signal having a negative phase of the specific sound on the specific sound as in the noise canceling technology, and a method of filtering the specific sound by a filter for suppressing a frequency component predominantly included in the specific sound.

In the presentation processing, the specific sound can be acoustically processed. In the acoustic processing for the specific sound, for example, it is possible to shift the pitch (height) of the specific sound, change the tone, or convert the specific sound into another sound. The conversion of the specific sound into another sound can be performed, for example, by muting the specific sound (e.g., “prrr . . . ”) and then mixing another sound (e.g., “pip pip pip . . . ”) or modulating a signal with a predetermined frequency band of the specific sound.

In addition, in the presentation processing, the fact that the specific sound is generated at the other point can be displayed. Further, in the presentation processing, the contents of the presentation processing can be displayed.

Note that the muting of the specific sound or the acoustic processing is executed in the telepresence system 10 so as to minimize the influence on sounds other than the specific sound as much as possible, which allows the user to feel a sense of connection at all times.

Processing of Telepresence System 10

FIG. 5 is a flowchart for describing an example of processing of the telepresence system 10.

In other words, FIG. 5 is a flowchart for describing an example of processing of the telepresence apparatuses 11A and 11B when bidirectional communication of images and sounds is performed between the telepresence apparatus 11A at the point A and the telepresence apparatus 11B at the point B.

In Step S11, the telepresence apparatus 11A requests the telepresence apparatus 11B to connect.

In Step S31, the telepresence apparatus 11B accepts the connection request from the telepresence apparatus 11A.

In Step S12, the telepresence apparatus 11A establishes a connection with the telepresence apparatus 11B.

In Step S32, the telepresence apparatus 11B establishes a connection with the telepresence apparatus 11A.

As described above, after the connection between the telepresence apparatuses 11A and 11B is established, bidirectional communication of images and sounds is started between the telepresence apparatuses 11A and 11B.

In Step S13, the telepresence apparatus 11A detects a signal sound at the point A.

In Step S14, the telepresence apparatus 11A transmits the detection result of the signal sound at the point A to the telepresence apparatus at the other point, here, to the telepresence apparatus 11B. In addition, the telepresence apparatus 11A transmits the detection result of the signal sound at the point A to the server 12. For example, the server 12 can set, as a specific sound, a signal sound common to each point among the signal sounds transmitted from the telepresence apparatuses 11 at the respective points, and transmit the specific sound to the telepresence apparatus 11 at each point.

In Step S15, the telepresence apparatus 11A receives the detection result of the signal sound at the other point, here, at the point B.

In other words, similarly to the telepresence apparatus 11A, the telepresence apparatus 11B at the point B transmits the detection result of the signal sound at the point B to the telepresence apparatus 11A, and thus the telepresence apparatus 11A receives the signal sound at the point B transmitted from the telepresence apparatus 11B. For example, the telepresence apparatus 11A that has received the signal sound at the point B can set, as a specific sound, a signal sound common to the signal sound at the point A among the signal sounds at the point B.

In Step S16, the telepresence apparatus 11A determines whether or not a specific sound generated at the point B is detected from the sound transmitted from the other point, here, the point B, i.e., the telepresence apparatus 11B.

If it is determined in Step S16 that a specific sound generated at the point B is not detected, that is, if a specific sound is not generated at the point B, the processing skips Steps S17 to S19 and proceeds to Step S20.

Alternatively, if it is determined in Step S16 that a specific sound generated at the point B is detected, that is, if a specific sound is generated at the point B, the processing proceeds to Step S17.

In Step S17, the telepresence apparatus 11A analyzes the specific sound generated at the point B, and determines whether to mute the specific sound, perform the presentation processing on the specific sound, or output the specific sound from the loudspeaker 41 without performing any processing thereon, according to the analysis result (for example, the type or meaning of the specific sound, or the like). In addition, if the telepresence apparatus 11A determines to execute the presentation processing, the telepresence apparatus 11A determines (the processing contents of) the presentation processing to be executed, for example, according to the analysis result of the specific sound or the like.

In Step S17, if the execution of the presentation processing and the presentation processing to be executed are determined, in Step S18, the telepresence apparatus 11A executes the presentation processing on the specific sound generated at the point B. In Step S19, the telepresence apparatus 11A then displays (the processing contents of) the presentation processing to be executed on the display 42 as necessary.

Further, if it is determined in Step S17 that muting is to be performed, in Step S18, the telepresence apparatus 11A mutes the specific sound generated at the point B. In Step S19, the telepresence apparatus 11A then displays the fact that muting is being performed, on the display 42, as necessary.

If it is determined in Step S17 that the specific sound generated at the point B is output from the loudspeaker 41 without performing any processing thereon, in Step S18, the telepresence apparatus 11A outputs the specific sound generated at the point B from the loudspeaker 41 as it is. In Step S19, the telepresence apparatus 11A then displays information of the specific sound generated at the point B on the display 42 as necessary. For example, the telepresence apparatus 11A can display information indicating that the specific sound is generated at the point B or what kind of specific sound is generated.

Note that, in Step S19, in a case where the execution of the presentation processing and the presentation processing to be executed are determined, and in a case where the muting is determined to be performed, information of the specific sound generated at the point B can be displayed on the display 42 as necessary.

In Step S20, the telepresence apparatus 11A determines whether an operation to disconnect the connection with the telepresence apparatus 11B has been performed or not, and if the telepresence apparatus 11A determines that the operation has not been performed, the processing returns to Step S13.

Alternatively, if it is determined in Step S20 that an operation to disconnect the connection with the telepresence apparatus 11B has been performed, the processing proceeds to Step S21.

In Step S21, the telepresence apparatus 11A requests the telepresence apparatus 11B to disconnect the connection. The telepresence apparatus 11A then disconnects the connection with the telepresence apparatus 11B, and the processing is terminated.

Meanwhile, in Steps S33 to S39, the telepresence apparatus 11B performs processing similar to Steps S13 to S19, respectively.

In Step S40, the telepresence apparatus 11B then determines whether or not there is a request to disconnect the connection with the telepresence apparatus 11A from the telepresence apparatus 11A, and if the telepresence apparatus 11B determines that there is no request, the processing returns to Step S33.

Alternatively, if it is determined in Step S40 that there is a request to disconnect the connection with the telepresence apparatus 11A, the processing proceeds to Step S41.

In Step S41, the telepresence apparatus 11B accepts the request of disconnection from the telepresence apparatus 11A, and disconnects the connection with the telepresence apparatus 11A, and the processing is terminated.

FIG. 6 is a diagram for describing a first example of a state of communication using the telepresence system 10.

Note that in FIG. 6, a microphone 31A, a loudspeaker 41A, and a display 42A represent the microphone 31, the loudspeaker 41, and the display 42 of the telepresence apparatus 11A at the point A, respectively. A microphone 31B, a loudspeaker 41B, and a display 42B represent the microphone 31, the loudspeaker 41, and the display 42 of the telepresence apparatus 11B at the point B, respectively. The same applies to the figures to be described later.

In FIG. 6, a user UA at the point A whose image is captured by the telepresence apparatus 11A is displayed on the display 42B of the telepresence apparatus 11B. In addition, a user UB at the point B whose image is captured by the telepresence apparatus 11B is displayed on the display 42A of the telepresence apparatus 11A.

The user UA at the point A talks to the user UB at the point B by the utterance “Hello” in an attempt to start communicating with the user UB at the point B.

In this case, the utterance “Hello” of the user UA is output by a sound from the loudspeaker 41B at the point B.

When the user UB at the point B responds to the utterance “Hello” of the user UA at the point A by the utterance “Hi”, the utterance “Hi” responded by the user UB is output by a sound from the loudspeaker 41A at the point A.

FIG. 7 is a diagram showing a second example of a state of communication using the telepresence system 10.

In FIG. 7, a nurse call “prrr . . . ” serving as a specific sound is generated at the point B.

The nurse call generated at the point B is collected by the microphone 31B and transmitted from the telepresence apparatus 11B at the point B to the telepresence apparatus 11A at the point A.

In the telepresence apparatus 11A, the nurse call serving as the specific sound generated at the point B, which is transmitted from the telepresence apparatus 11B, is detected.

In FIG. 7, in the telepresence apparatus 11A, the nurse call serving as the specific sound generated at the point B is muted.

In addition, in FIG. 7, in the telepresence apparatus 11A, a message “The nurse call at the point B is muted.” is displayed on the display 42A as presentation processing.

According to the display of the message “The nurse call at the point B is muted.”, the user UA at the point A can recognize that the nurse call at the point B is muted and that the nurse call is generated (ringing) at the point B.

Therefore, when the display of the message “The nurse call at the point B is muted.” is executed as the presentation processing, it can be said that the presentation indicating that the nurse call serving as the specific sound generated at the other point B is not a sound generated at the point A is being performed for the user UA at the point A.

FIG. 8 is a diagram showing a third example of a state of communication using the telepresence system 10.

In FIG. 8, a nurse call “prrr . . . ” serving as a specific sound is generated at the point B.

The nurse call generated at the point B is collected by the microphone 31B and transmitted from the telepresence apparatus 11B at the point B to the telepresence apparatus 11A at the point A.

In the telepresence apparatus 11A, the nurse call serving as the specific sound generated at the point B, which is transmitted from the telepresence apparatus 11B, is detected.

In FIG. 8, in the telepresence apparatus 11A, acoustic processing for the nurse call serving as the specific sound generated at the point B is executed as the presentation processing. Thus, the nurse call “prrr . . . ” generated at the point B is converted into another sound “beep beep . . . ”. In addition, in FIG. 8, the other sound “beep beep . . . ” is output from the loudspeaker 41A.

Further, in FIG. 8, the telepresence apparatus 11A displays a message “A nurse call is ringing at the point B.” on the display 42A as the presentation processing. In addition, a message “A nurse call at the point B is converted into another sound.” indicating the processing contents of the acoustic processing for the nurse call as the presentation processing is displayed on the display 42A.

According to the display of the message “A nurse call is ringing at the point B.”, the user UA at the point A can recognize that the nurse call is ringing at the point B. Similarly, the user UA at the point A can also recognize that the nurse call is ringing at the point B by conversion of the nurse call “prrr . . . ” generated at the point B into another sound “beep beep . . . ” and output of the sound from the loudspeaker 41A.

Therefore, when the display of the message “A nurse call is ringing at the point B.” is executed as the presentation processing, it can be said that the presentation indicating that the nurse call serving as the specific sound generated at the other point B is not a sound generated at the point A is being performed for the user UA at the point A. The same applies to the presentation processing of converting the nurse call “prrr . . . ” generated at the point B into another sound “beep beep . . . ” and outputting the sound from the loudspeaker 41A.

Further, according to the message “A nurse call at the point B is converted into another sound.”, the user UA of the point A can recognize that the nurse call “prrr . . . ” generated at the point B is converted into another sound “beep beep . . . ” and output from the loudspeaker 41A.

FIG. 9 is a diagram showing a fourth example of a state of communication using the telepresence system 10.

In FIG. 9, a nurse call “prrr . . . ” serving as a specific sound is generated at the point B.

The nurse call generated at the point B is collected by the microphone 31B and transmitted from the telepresence apparatus 11B at the point B to the telepresence apparatus 11A at the point A.

In the telepresence apparatus 11A, the nurse call serving as the specific sound generated at the point B, which is transmitted from the telepresence apparatus 11B, is detected.

In FIG. 9, in the telepresence apparatus 11A, the nurse call “prrr . . . ” generated at the point B is output from the loudspeaker 41A as it is.

In addition, in FIG. 9, the telepresence apparatus 11A displays a message “A nurse call is ringing at the point B.” on the display 42A as the presentation processing.

In FIG. 9, since the nurse call “prrr . . . ” generated at the point B is output from the loudspeaker 41A as it is, the user UA at the point A may mistakenly think that the nurse call is ringing at the point A.

However, in FIG. 9, the message “A nurse call is ringing at the point B.” is displayed on the display 42A. By viewing the message “A nurse call is ringing at the point B.”, the user UA at the point A can recognize that the nurse call is generated at the point B and that the nurse call “prrr . . . ” output from the loudspeaker 41A is not a sound generated at the point A.

Therefore, when the display of the message “A nurse call is ringing at the point B.” is executed as the presentation processing, it can be said that the presentation indicating that the nurse call serving as the specific sound generated at the other point B is not a sound generated at the point A is being performed for the user UA at the point A.

As described above, for example, in a case where a specific sound is generated at the point B, the presentation processing for presentation indicating that the specific sound generated at the point B is not a sound generated at the point A is executed, thus preventing the user UA at the point A from mistakenly thinking that the specific sound generated at the point B is generated at the point A.

Note that part of the processing performed by the telepresence apparatus 11 can be performed by the server 12.

Description of Computer to which Present Technology is Applied

Next, the series of processing of the signal processing device 23 described above can be performed by hardware or by software. In a case where the series of processing is performed by software, a program constituting the software is installed on a general-purpose computer or the like.

FIG. 10 is a block diagram showing a configuration example of an embodiment of a computer on which a program for executing the series of processing described above is installed.

The program can be recorded in advance in a hard disk 905 or a read only memory (ROM) 903 as a recording medium built in the computer.

Alternatively, the program can be stored (recorded) on a removable recording medium 911 driven by a drive 909. Such a removable recording medium 911 can be provided as so-called package software. Here, examples of the removable recording medium 911 include a flexible disk, a compact disc read only memory (CD-ROM), a magneto-optical (MO) disk, a digital versatile disc (DVD), a magnetic disk, and a semiconductor memory.

Note that, in addition to installing the program on the computer from the removable recording medium 911 as described above, the program can be downloaded to the computer and installed on the built-in hard disk 905 through a communication network or a broadcast network. In other words, the program can be wirelessly transferred to the computer, for example, from a download site via an artificial satellite for digital satellite broadcasting, or transferred to the computer by wire via a network such as a local area network (LAN) or the Internet.

The computer includes a central processing unit (CPU) 902, and an input/output interface 910 is connected to the CPU 902 through a bus 901.

The CPU 902 executes a program stored in the ROM 903 according to a command, which is input through the input/output interface 910 by the user operating an input unit 907, for example. Alternatively, the CPU 902 loads a program stored in the hard disk 905 into a random access memory (RAM) 904 and executes the program.

As a result, the CPU 902 performs the processing according to the flowchart described above or the processing performed by the configuration of the block diagrams described above. The CPU 902 then outputs the processing result from an output unit 906 or transmits the processing result from a communication unit 908, and further records the processing result on the hard disk 905, for example, through the input/output interface 910, as necessary.

Note that the input unit 907 includes a keyboard, a mouse, a microphone, or the like. Further, the output unit 906 includes a liquid crystal display (LCD), a speaker, or the like.

Here, in this specification, the processing performed by the computer according to the program does not necessarily have to be performed in time series in the order described as a flowchart. In other words, the processing performed by the computer according to the program includes the processing executed in parallel or individually (for example, parallel processing or processing by an object).

Further, the program may be processed by one computer (processor) or may be distributed and processed by a plurality of computers. In addition, the program may be transferred to and executed by a remote computer.

In addition, in this specification, the system means a collection of a plurality of constituent elements (apparatuses, modules (components), etc.), and whether or not all the constituent elements are in the same housing is not limited. Therefore, a plurality of apparatuses accommodated in separate housings and connected to one another through a network, and a single apparatus in which a plurality of modules is accommodated in a single housing are both systems.

Note that the embodiment of the present technology is not limited to the embodiment described above and variously modified without departing from the gist of the present technology.

For example, the present technology may also have a configuration of cloud computing in which a plurality of apparatuses shares tasks of a single function and works collaboratively to perform the single function via a network.

Further, the respective steps described using the flowchart described above may be shared by a plurality of apparatuses to be performed, in addition to being performed by a single apparatus.

Moreover, when a single step includes a plurality of processes, the plurality of processes included in the single step may be shared by a plurality of apparatuses to be performed, in addition to being performed by a single apparatus.

In addition, the effects described herein are merely illustrative and not restrictive, and other effects may be present.

Note that the present technology can have the following configurations.

<1> An information processing apparatus, including

a presentation processing unit that executes, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

<2> The information processing apparatus according to <1>, in which

the presentation processing unit acoustically processes and outputs the specific sound.

<3> The information processing apparatus according to <2>, in which

the presentation processing unit shifts a pitch of the specific sound.

<4> The information processing apparatus according to <2>, in which

the presentation processing unit converts the specific sound into another sound.

<5> The information processing apparatus according to any one of <1> to <4>, in which

the presentation processing unit displays a fact that the specific sound is generated at the other point.

<6> The information processing apparatus according to <5>, in which

the presentation processing unit mutes the specific sound.

<7> The information processing apparatus according to any one of <1> to <6>, in which

the presentation processing unit displays contents of the presentation processing.

<8> The information processing apparatus according to any one of <1> to <7>, in which

the presentation processing unit displays information of the specific sound generated at the other point.

<9> The information processing apparatus according to any one of <1> to <8>, in which

the specific sound is a sound generated in common at the one point and the other point.

<10> An information processing method, including

executing, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

<11> A program, which causes a computer to function as a presentation processing unit that executes, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising
a presentation processing unit that executes, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

2. The information processing apparatus according to claim 1, wherein
the presentation processing unit acoustically processes and outputs the specific sound.

3. The information processing apparatus according to claim 2, wherein
the presentation processing unit shifts a pitch of the specific sound.

4. The information processing apparatus according to claim 2, wherein
the presentation processing unit converts the specific sound into another sound.

5. The information processing apparatus according to claim 1, wherein
the presentation processing unit displays a fact that the specific sound is generated at the other point.

6. The information processing apparatus according to claim 5, wherein
the presentation processing unit mutes the specific sound.

7. The information processing apparatus according to claim 1, wherein
the presentation processing unit displays contents of the presentation processing.

8. The information processing apparatus according to claim 1, wherein
the presentation processing unit displays information of the specific sound generated at the other point.

9. The information processing apparatus according to claim 1, wherein
the specific sound is a sound generated in common at the one point and the other point.

10. An information processing method, comprising
executing, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.

11. A program, which causes a computer to function as a presentation processing unit that executes, when a specific sound is generated at another point other than one of a plurality of points, presentation processing for presentation indicating that the specific sound generated at the other point is not a sound generated at the one point, each of the plurality of points having a telepresence apparatus constituting a telepresence system that performs bidirectional communication of images and sounds for communication between users located at the plurality of points.
